(19) United States
(12) Patent Application Publication
(10) Pub. No.: US 2012/0123836 A1
(43) Pub. Date: May 17, 2012

(54) SYSTEMS AND METHODS FOR DRIVING INTERNET TRAFFIC

(75) Inventors: Andrew E. Duke, North Augusta, SC (US); Thomas D. Wafford, North Augusta, SC (US); Benjamin H. Hancock, Grovetown, GA (US)

(73) Assignee: ADTRIAD, LLC, North Augusta, SC (US)

(21) Appl. No.: 13/253,407

(22) Filed: Oct. 5, 2011

Related U.S. Application Data
(60) Provisional application No. 61/389,818, filed on Oct. 5, 2010.

(51) Int. Cl. G06Q 30/02

(52) U.S. Cl. 705/14.14; 705/14.27; 705/14.1

(57) ABSTRACT

A system and method for driving internet traffic to a coupon website is described. The website can provide low-cost, high traffic advertising to vendors by providing coupons. Traffic to the website can be enhanced by providing a variety of incentives. The incentives can include points, free prizes, and cash incentives. The site can be flexible and adaptable enabling vendors to change coupons and/or offers during the pendency of their contract. The site can be geographically limited to a small number of vendors to increase site demand and decrease vendor competition. The site can comprise a non-exclusive geographical site to increase traffic and improved economies of scale. The site can be divided into zones or areas to provide relevant information to consumers based on geographical, or other, data. The site can provide a variety of payment options including paying all or part of the listing fee with vendor coupons.

### CROSS-REFERENCE TO RELATED APPLICATIONS

This application claims benefit under 35 USC §119(e) of U.S. Provisional Patent Application Ser. No. 61/389,818 filed 5 Oct. 2010, which is incorporated herein by reference as if fully set forth below in its entirety.

### BACKGROUND OF THE INVENTION

1. Field of the Invention

The present invention relates generally to driving internet traffic to a website, and specifically to increasing internet website traffic by offering vendor and/or manufacturer-based coupons coupled with cash and prize giveaways.

2. Background of Related Art

Websites exist that offer advertising to vendors or manufacturers (collectively, “vendors”) in exchange for a fee. These sites typically offer, for example, a one-month advertisement using a coupon provided by the vendor. Consumers can then go to the website and select coupons based, on for example, value, location, or convenience.

An example of such a website is www.coupons.com (“Coupons”). Coupons provides a central repository for both vendor-based and manufacturer-based coupons. At the outset, the website asks you for your zip code to tailor the coupon offers geographically as needed. Coupon includes manufacturer-based coupons for discounts on nationally advertised goods and services. Coupon also offers coupons for goods and services for locally based vendors, such as for example, tire stores and restaurants.

A website that takes a slightly different approach is www.groupon.com (“Groupon”). Groupon offers a single “deal” for a specific period of time or a specific number of offers. The deal may include goods or services and can be geographically tailored as necessary. Groupon offers only one deal at a time, which tends to focus attention on that particular deal. After the deal has expired or sold-out, a new deal is posted and the previous deal is no longer available.

Conventionally, the traffic, and ultimately the success, of a particular coupon website has been driven almost entirely by the value of the coupons and the relevance of the vendors. Obviously, a 50% coupon from a highly desirable vendor generally creates more traffic than a 5% off coupon for a Mom and Pop convenient store. In addition, coupon websites have thus far tended to follow outdated print ad paradigms. In other words, a vendor is generally forced to buy a single coupon for a set amount of time (e.g., one month) for a fixed price. This system ignored the flexibility inherent in digital internet-based media.

What is needed, therefore, is a system and method for driving internet traffic to a coupon website that is not driven entirely by the value or desirability of the coupons themselves. The site should be readily updateable by vendors to enable customization and to generate interest. It is to such a system and method that embodiments of the present invention are primarily directed.

### SUMMARY OF THE INVENTION

The present invention relates generally to systems and methods for driving internet traffic to a website, and specifically to increasing internet website traffic by offering vendor and/or manufacturer-based coupons coupled with cash and prize giveaways. Users are incentivized to both visit the site and browse the site and can be given, for example, points, miles, or drawing entries based on their site use.

In some embodiments, the site can be geographically limited to provide locally relevant coupons to users. In other embodiments, the site may limit the total number of vendors that can participate to raise demand and reduce vendor competition. In some embodiments, the vendors may be limited based on the type of business, locations, or other factors to reduce cross-competition between participating vendors.

In some embodiments, the site can award users an entry into a daily, monthly, or weekly drawing. The entries can be awarded, for example and not limitation, on the number of days or times they visit the site, the total time they spend on the site, or the number of coupons they view, download, or print. In other embodiments, the site can award users miles or points, similar to airline frequent flier programs. Users can exchange points for items, including but not limited to, goods, services, gift certificates, and cash. In still other embodiments, users may, for example, be able to upgrade site coupons using points to increase their value.

In some embodiments, the site can provide advertising services to vendors at no upfront cost. The cost to operate the site can be recouped by the operator, for example and not limitation, by selling an initial number of coupons or vouchers. After the site cost has been recouped the site can then charge a nominal transaction fee for each coupon or voucher sold, with the vendor retaining the remainder. In this manner, a new or small business can receive valuable advertising with little or no upfront cost.

Embodiments of the present invention can also comprise software designed to provide such a site. Embodiments of the present invention can also comprise a system including an internet-connected computer, an internet connection, and software configured to provide such a website. In some embodiments, the software or website can be uploaded to an internet service provider or web-hosting provider.

Embodiments of the present invention can comprise a computer-implemented method for increasing traffic to a coupon-based website comprising receiving a plurality of coupons from a vendor, listing the plurality of coupons via one or more electronic media outlets, providing one or more additional incentives to increase traffic to the website, and allocating the one or more additional incentives to one or more users. The one or more additional incentives can comprise points redeemable for cash, prizes, or both. In some embodiments, the one or more users can earn points by participating in qualifying events on the website.

In some embodiments, the one or more additional incentives can be allocated to the user who has earned the most points in a predetermined time period. In other embodiments, the qualifying events can comprise purchasing one or more coupons from the website. In still other embodiments, the qualifying events can comprise visiting the website one or more times per day. In yet other embodiments, the qualifying events can comprise viewing one or more coupons on the website.

In some embodiments, the one or more additional incentives can be allocated as the result of a random drawing of the one or more users that have accessed the website in a predetermined time period. In other embodiments, the one or more additional incentives can be allocated to the user who has purchased the highest number of coupons in a predetermined time period. In still other embodiments, the one or more additional incentives can be allocated to the user who has purchased the highest value of coupons in a predetermined time period.

Embodiments of the present invention can also comprise a computer-implemented method for purchasing a listing on a website with improved traffic-flow comprising receiving a plurality of coupons from a vendor, listing the plurality of coupons via one or more electronic media outlets, and selling the plurality of coupons to one or more users. The value of the plurality of coupons sold can be paid to a provider of the website until a listing fee is paid. Afterwards, the value of the plurality of coupons sold above the listing fee can be paid to the vendor. In some embodiments, if the value of the coupons sold is below the listing fee, the vendor can provide additional coupons to the provider to provide additional incentives for users to visit the website.

In some embodiments, a percentage of the value of the plurality of coupons sold that is above the listing fee is paid to the provider as a transaction fee and the remainder is paid to the vendor. In some embodiments, the vendor can receive a discounted listing fee from the provider by providing additional coupons to the provider to provide additional incentives for users to visit the website.

The foregoing and other objects, features, aspects, and advantages of the present invention will become more apparent from the following detailed description of the present invention.

### BRIEF DESCRIPTION OF THE DRAWINGS

FIG. 1 depicts a flowchart of an accounting and payment system for an incentive based coupon website, in accordance with some embodiments of the present invention.

### DETAILED DESCRIPTION

Embodiments of the present invention relate generally to a system and method for driving traffic to an internet coupon website. The website can provide coupons from vendors in conjunction with various incentive programs associated with the website, the coupons, or both. The system can use, for example, cash giveaways, prizes, and/or points to incent internet users to regularly visit the site. The site can also offer vendors the flexibility to change their coupons or offers on a regular basis. The site can be limited to, for example and not limitation, a certain number of vendors, vendors in a geographical area, or vendors in a particular industry. The site can also provide users with periodic e-mails alerting them to current deals.

To simplify and clarify explanation, the system is described below as a system for providing an advertising outlet for “vendors.” One skilled in the art will recognize that this term can encompass a variety of entities, including but not limited to, local and national businesses, sole proprietors, and vendors of both goods and/or services. The system is also described below as a website for providing vendor “coupons” or “vouchers.” The terms coupon and voucher can encompass a variety of offers, including but not limited to, providing percentage, monetary, two for one, but one get one free, or other discounts and can be for goods or services.

A problem with conventional coupon websites is that traffic is driven to the sites based mainly on the desirability of the vendors and the value of the coupons or offers. This presents a distinct disadvantage to small or local vendors that may not have, for example, the brand name recognition of a large multinational corporation. Small businesses also may not have the resources to offer and sell their products or services at deep discounts. Small businesses may additionally not have the inventory to support a large influx of orders for a particular product.

What is needed, therefore, is a system and method for providing a website that provides additional incentives to stimulate traffic, both to the site and to individual coupons or offers, and enables vendors the ability to change their offers and/or coupons often. It is to such a system and method that embodiments of the present invention are primarily directed.

Embodiments of the present invention relate to a method for providing a coupon website with enhanced traffic flow. Traffic flow is improved by providing both coupons from vendors and additional incentives. The incentives can be based, for example and not limitation, on the amount of time a user spends on the website, the number of offers the user views, or the number of “click-throughs” the user follows (e.g., the number of links the user clicks on that lead to vendors' websites).

In order to be listed on the website, vendors can, for example, fill out a form providing location, billing, and other relevant information and pay a fee. In some embodiments, the fee can be time based (e.g., $99/month). In other embodiments, the fee can be traffic, or “hit,” based and can be based, for example and not limitation, on the number of hits generated by the site as a whole or the number of hits on a particular coupon. In this embodiment, the vendor pays more for more hits in return for greater exposure. In still other embodiments, the vendor can pay for a listing on the site with the coupons themselves. In other words, the site provider keeps the proceeds from coupon sales until the cost of the site for that vendor is paid. If the vendor does not have sufficient sales to cover their site costs, the provider may use additional coupons as giveaways or additional incentives to cover the difference.

In some embodiments, the vendors can be divided into categories. The vendors can, for example, be divided into geographical areas so that the coupons provided on the site are geographically relevant. In some embodiments, vendors can be sorted based on the types of goods and services provided. This can prevent excessive cross-competition between vendors listed on the site. In other words, having eight jewelry stores located in the same basic area advertising on the same site is not very useful and can create undue competition. In some embodiments, the total number of vendors, or the total number of vendors in a particular category, can be limited. Limitation can provide exclusivity to the website and drive demand. Limitation can also increase the exposure of vendors that are listed and prevent smaller vendors, for example, from being “lost in the shuffle.” In other embodiments, such as in large metropolitan areas, for example, the site may not be limited and can essentially act as a central clearinghouse.

To prevent website traffic from being driven solely by the types of vendors and the value of the coupons, the website can also provide additional incentives. These incentives can include, for example and not limitation, cash prizes, gift certificates, or debit cards. The incentives can be based on the number of times a user accesses the site, the number of coupons he views, or the number he downloads and/or prints. In this manner, the user is incentivized to visit the site for both the value of the coupons and the real, or potential, value of the incentives.

The incentives can be allotted in a variety of ways. In some embodiments, website users can be given an entry into a monthly drawing based on their use of the website. If the user visits the website every day, for example, the user can be entered into the monthly drawing 30 times. In other embodiments, the user can be entered into the monthly drawing based on, for example and not limitation, the number of click-throughs or the number of coupons he views or prints. In this manner, each user can potentially earn hundreds of entries into the monthly drawing. Thus, while the incentives remain somewhat chance based, the user can improve his chances radically by visiting the site often and/or spending more time on the site.

In some embodiments, the user can earn points, or miles, based on their use of the website. Similar to the drawing entries above, the user can earn points in a variety of ways based on their use of the website. In some embodiments, the user can exchange points for, for example and not limitation, merchandise, cash, or travel. In some embodiments, the user who earns the most points during a given time period, e.g., a month, can automatically win a monthly prize. Of course, the frequency of any drawing or prizes can be varied based on web site traffic or other factors.

Conventional coupon sites have typical maintained a rigid structure, possibly as an artifact of traditional print ad sales. As a result, these sites tend to sell vendors a single coupon for a set amount of time (e.g., weekly or monthly). This scheme fails to exploit the adaptability of internet published digital media. Embodiments of the present invention, therefore, can enable vendors to update their coupons on a regular basis. In some embodiments, vendors can update their coupons weekly, daily, or even hourly. This enables vendors to tailor their coupons based on, for example and not limitation, the number of coupons printed, the time of day, inventory levels, or even expiration dates. This can be particularly useful for small businesses that have limited inventories. In other words, the system can be used to prevent 100 people from showing up for ten items.

In practice a local tire store attempting to clear old inventory, for example, can offer a special deal on a particular size or brand of tire. When all of a particular size or brand has been sold, the vendor need only go online and change the coupon to reflect the next size or brand to be sold. A restaurant, on the other hand, could offer a lunch special, then a happy hour special, and then a dinner special. The restaurant could offer a different special multiple times a day, every day. The restaurant could also tailor coupons to consume perishable items that are approaching their expiration date to reduce the costs associated with spoilage. In a preferred embodiment, vendors can change their offer up to once per hour, 24 hours a day.

In some embodiments, the coupons and website can be configured to interface with social networking sites and other internet-based media. In some embodiments, for example, the coupons can be limited to 140 characters to provide compatibility with Twitter, Facebook, and other microblogging sites. In some embodiments, the site can be available as an application for execution on smart phones and other internet enabled devices (e.g., iPod touch, iPad, etc.).

Providing additional incentives above the coupons themselves can be particularly useful for small businesses. Small businesses, for example, may have less brand recognition and may be less able to provide deep discounts or highly valuable coupons or certificates. As a result, on a conventional coupon site, these businesses would tend to be overlooked in favor of, for example, nationally known chains or companies offering large discounts. With the additional incentives provided herein, however, users can be provided with the additional incentive of earning points, or entries, for each coupon they view.

In this manner, a user may click on a particular coupon just to earn points, but then may find the coupon particularly attractive. A user may click on a less valuable coupon only to find that the vendor is, for example, very conveniently located, American owned, or specially certified. As a result, the user may take advantage of a less valuable coupon based on its intangible value. In addition, the exposure provided by users simply viewing a particular vendor's coupons helps to build brand recognition that can indirectly lead to increased business.

In some embodiments, vendors may be able to purchase preferred exposure. In other words, for an additional fee, vendors can purchase premium packages that feature their coupon on the home page of the site. Vendors can also purchase packages that feature their coupon in a periodic e-mail from the provider. Vendors can also choose to provide additional coupons to be included as prizes or giveaways to increase foot traffic at minimal actual cost.

Embodiments of the present invention, therefore, can comprise a method for providing a coupon website with additional incentives to increase user interest and drive traffic. In other embodiments, the present invention can comprise a software program configured to run such a website on an internet based computer. In other embodiments, the present invention can comprise a software program configured to load such a website onto the servers of an internet service provider or web-hosting provider. In other embodiments, the present invention can comprise a system including program, an internet connected computer, and an internet connection configured to provide such a website.

Embodiments of the present invention can provide national advertising exposure to vendors with little or no initial investment. In other words, rather than paying for the service up front, the vendor can provide an equivalent number of vouchers or coupons to the provider to cover the cost of the site. In this manner, the vendor has no initial outlay to be listed on the site and, in fact, has this cost deferred until the coupons are actually redeemed. This may defer the actual cost to the vendor for days, weeks, or even months, as consumers often purchase the coupons, for example, for special events in the future.

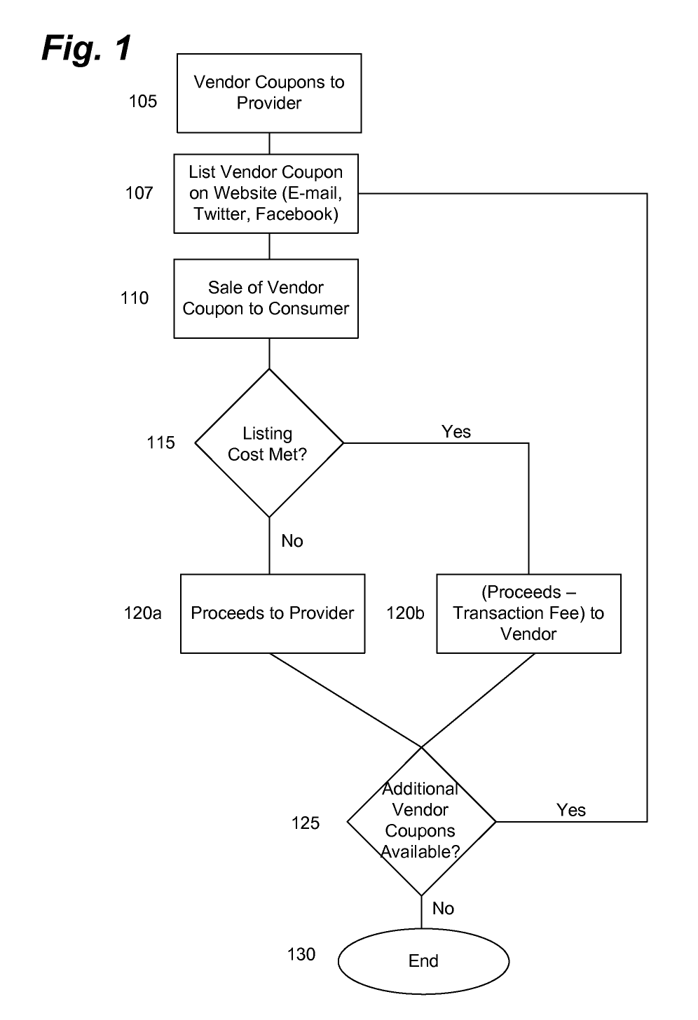

As shown in FIG. 1, embodiments of the present invention can comprise a system 100 in which the vendor can provide the provider with a number of coupons 105 for a particular product or deal, for example. The provider can then list the coupon 107 on, for example and not limitation, a website, Twitter, and/or Facebook. In some embodiments, the vendor may also send out an e-mail to subscribers including daily, weekly, or monthly deals. In some embodiments, the level of exposure can be based on the “package” purchased by the vendor. A basic package, for example, may include listing and indexing on one of the pages of the website only. A deluxe package, on the other hand, can include, for example and not limitation, a prominent listing on the homepage of the website and repeated e-mails and Facebook mentions.

In some embodiments, when a coupon is sold 110 for a particular vendor to a consumer, the provider checks 115 to see if the vendor has either paid for the listing up front or has sold enough coupons to cover the cost of the listing. If the vendor has not covered the cost of the listing, the provider keeps the proceeds from the sale of the coupon 120a. If the vendor has sold enough coupons to cover the listing cost, on the other hand, then the proceeds are debited to the vendor's account 120b. In some embodiments, the provider may take a percentage of each coupon sold as a transaction fee to cover, for example, variable costs such as bandwidth and credit card transaction fees.

The provider can then check 125 to ensure that the vendor has additional coupons available, i.e., to ensure that the vendor does not sell out of a particular item. If the vendor still has coupons available, then the provider can relist 107 the coupon and the process restarts. If the vendor has not coupons, on the other hand, the process can end 130. In some embodiment, ending the process 130 can trigger an e-mail, or other communication (e.g., text message, voicemail, Tweet, etc.) from the provider to the vendor to inquire if the vendor would like to list additional items or deals.

In some embodiments, the provider can provide a periodic (e.g., weekly or monthly) accounting to the vendor. If the vendor has had sales in excess of that required to cover their listing cost, for example, the provider can send the vendor a check (or other form of payment) for (the total sales-the listing cost-transaction fees). In other embodiments, the vendor may have an electronic account that is accessible, for example, online. In this embodiment, the vendor may be able to withdraw or transfer funds from the account at any time. In some embodiments, the provider may require a minimum balance to cover the cost of additional months of listing.

If the vendor has not sold enough coupons to cover the listing cost, the vendor can pay the balance at the end of the month. Alternatively, the vendor can provide additional coupons to the provider for use in, for example, giveaways. In this manner, the vendor has no initial cash outlay and the giveaways themselves are no cost to the provider. In addition, while the vendor has theoretically lost the face value of the coupon, the coupon reflects retail pricing. In other words, by definition, there is some markup in the retail prices (i.e., they are retail and not wholesale prices). In addition, the coupon should increase traffic for the vendor, which can lead to additional business for the vendor by word of mouth and other intangible means (e.g., a busy restaurant looks more attractive to new customers).

While several possible embodiments are disclosed above, embodiments of the present invention are not so limited. For instance, while several possible methods and configurations for providing a coupon and incentive based website have been provided, other suitable configurations and combinations could be selected without departing from the spirit of embodiments of the invention. In addition, the location and configuration used for various features of embodiments of the present invention can be varied according to a particular network or internet configuration that require a slight variation due to, for example, the routers, firewalls, and/or space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A computer-implemented method for increasing traffic to a coupon-based website comprising:
receiving a plurality of coupons from a vendor;
listing the plurality of coupons via one or more electronic media outlets;
providing one or more additional incentives to increase traffic to the website; and
allocating the one or more additional incentives to one or more users.

2. The method of claim 1, wherein the one or more additional incentives comprises points redeemable for cash, prizes, or both.

3. The method of claim 2, wherein the one or more users earn points by participating in qualifying events on the website.

4. The method of claim 3, wherein the one or more additional incentives are allocated to the user who has earned the most points in a predetermined time period.

5. The method of claim 3, wherein the qualifying events comprise purchasing one or more coupons from the website.

6. The method of claim 3, wherein the qualifying events comprise visiting the website one or more times per day.

7. The method of claim 3, wherein the qualifying events comprise viewing one or more coupons on the website.

8. The method of claim 1, wherein the one or more additional incentives are allocated as the result of a random drawing of the one or more users that have accessed the website in a predetermined time period.

9. The method of claim 1, wherein the one or more additional incentives are allocated to the user who has purchased the highest number of coupons in a predetermined time period.

10. The method of claim 1, wherein the one or more additional incentives are allocated to the user who has purchased the highest value of coupons in a predetermined time period.

11. A computer-implemented method for purchasing a listing on a website with improved traffic-flow comprising:
receiving a plurality of coupons from a vendor;
listing the plurality of coupons via one or more electronic media outlets; and
selling the plurality of coupons to one or more users;
wherein the value of the plurality of coupons sold is paid to a provider of the website until a listing fee is paid; and
wherein the value of the plurality of coupons sold above the listing fee is paid to the vendor.

12. The method of claim 11, wherein if the value of the coupons sold is below the listing fee, the vendor can provide additional coupons to the provider to provide additional incentives for users to visit the website.

13. The method of claim 11, wherein a percentage of the value of the plurality of coupons sold above the listing fee is paid to the provider and the remainder is paid to the vendor.

14. The method of claim 11, wherein the vendor can receive a discounted listing fee from the provider by providing additional coupons to the provider to provide additional incentives for users to visit the website.
